(19) United States
(12) Patent Application Publication
(10) Pub. No.: US 2006/0092788 A1
(43) Pub. Date: May 4, 2006

(54) Method for reading an optical disc

(75) Inventor: Tao-Yen Wei, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/261,477

(22) Filed: Oct. 31, 2005

(30) Foreign Application Priority Data
Nov. 1, 2004 (TW) 93133271

(51) Int. Cl. G11B 7/00

(52) U.S. Cl. 369/47.25; 369/53.11; 369/53.12

(57) ABSTRACT

A method for reading data from the optical disc at a reading speed. The method includes the steps of (a) reading the data according to a preset amplified signal corresponding to the reading speed; (b) determining if the reading is successful: if so, terminate the method; otherwise, proceed to the next step; (c) adjusting the preset amplified signal to a corrected amplified signal according to a reading error index value; (d) re-reading the data according to the amplified signal adjusted and corrected in the step (c); and (e) determining if the reading is successful: if not successful, repeat step (c).

This application claims the benefit of Taiwan application Serial No. 93133271, filed Nov. 1, 2004, the subject matter of which is incorporated herein by reference.

### BACKGROUND OF THE INVENTION

1. Field of the Invention

The invention relates in general to a reading method, and more particularly to a method for reading an optical disc.

2. Description of the Related Art

Referring to FIG. 1, a block diagram of a conventional optical read/write control system is shown. An optical read/write control system 100 at least includes an optical pickup head 110, a radio frequency equalizer 120 and a digital signal processing (DSP) unit 130. The DSP unit 130 includes a decoder 132 and an error corrector 134.

When the optical read/write control system 100 reads out a data stored at an address of an optical disc 111 at a reading speed of 52×, the optical pickup head 110 emits a laser beam L to the optical disc 111 and reads out a radio frequency signal RF1. The radio frequency signal RF1 is derived from the reflected light from the optical disc 111 and outputted to a radio frequency equalizer 120. The radio frequency equalizer 120, according to an amplified signal AS and a cut off frequency COF corresponding to the reading speed of 52×, amplifies the radio frequency signal RF1 then outputs a radio frequency signal RF2 to the decoder 132. The amplified signal AS and the cut off frequency COF have various values preset according to various reading speeds and recorded in the optical read/write control system 100 before leaving the factory.

A decoder 132 decodes the radio frequency signal RF2 then outputs a data DA1 to the error corrector 134. If data DA1 can be corrected by an error corrector 134, the error corrector 134 corrects the data DA1 then outputs a corrected data DA2 to complete the reading of the data at the address.

If the error corrector 134 cannot be correct the data DA1 to be the data DA2, according to the conventional method, the optical read/write control system 100 uses the same amplified signal AS and cut off frequency COF to re-reads the data at the same reading speed. If the data stored at the address still cannot be successfully read out after 6 repeats, the optical read/write control system 100 would reduce the reading speed from 52× to 48× for instance, then re-read the data stored at the address until the data are successfully read out.

However, when the radio frequency equalizer 120 amplifies the radio frequency signal RF1 according to the amplified signal AS and the cut off frequency COF corresponding to the reading speed, the noises existing in the radio frequency signal RF1 due to poor writing quality may be amplified and outputted to the decoder 132 to be decoded as well. Therefore, the data DA1 outputted by the decoder 132 are erroneous data and cannot be corrected to be the data DA2 via the error corrector 134. Meanwhile, according to a conventional method of processing data reading error, the data at the same address is re-read at the same reading speed according to the same amplified signal AS and cut off frequency COF. By doing so, the noises existing in the radio frequency signal RF1 would be mistaken to be data, and then be amplified and decoded accordingly. Consequently, not only is the optical read/write control system 100 unable to correctly read out the data stored at the address, but also more time is wasted in reading the data at the same address.

### SUMMARY OF THE INVENTION

It is therefore an object of the invention to provide a reading method for reading out the data stored in an optical disc with a poor writing quality so as to enhance the reading ability of an optical disc drive.

The invention achieves the above-identified object by providing a method for reading an optical disc at a reading speed. The method includes the steps of (a) reading the data according to a preset amplified signal corresponding to the reading speed; (b) determining if the reading is successful: if so, terminate the method; otherwise, proceed to the next step; (c) adjusting the preset amplified signal to a corrected amplified signal according to a reading error index value; (d) re-reading the data according to the amplified signal adjusted and corrected in the step (c); and (e) determining if the reading is successful: if not successful, repeat step (c).

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a conventional optical read/write control system;

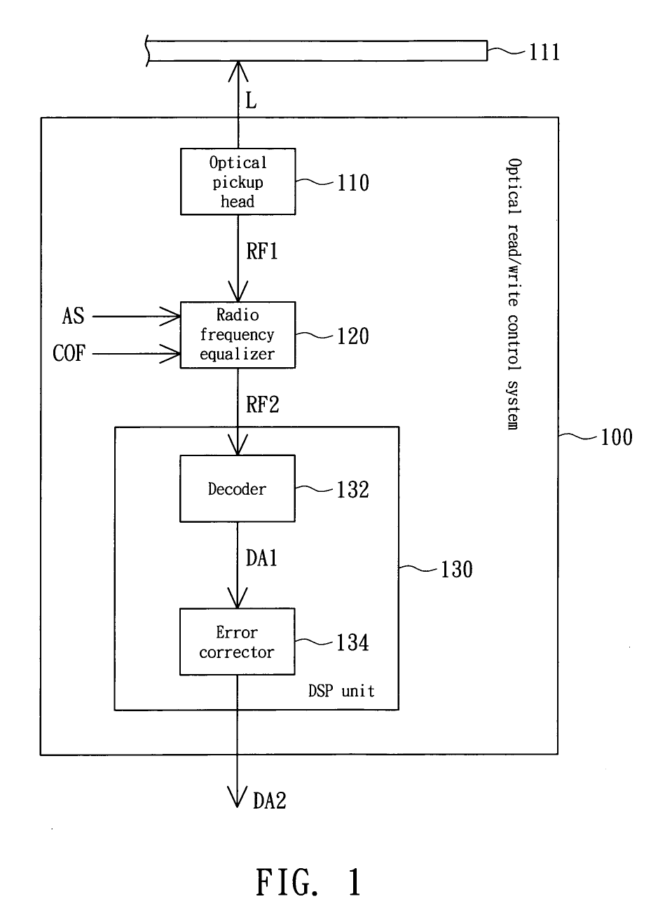

FIG. 2 is a flowchart of a reading method according to a preferred embodiment of the invention; and

FIG. 3 is a Bode diagram of an amplified signal.

### DETAILED DESCRIPTION OF THE INVENTION

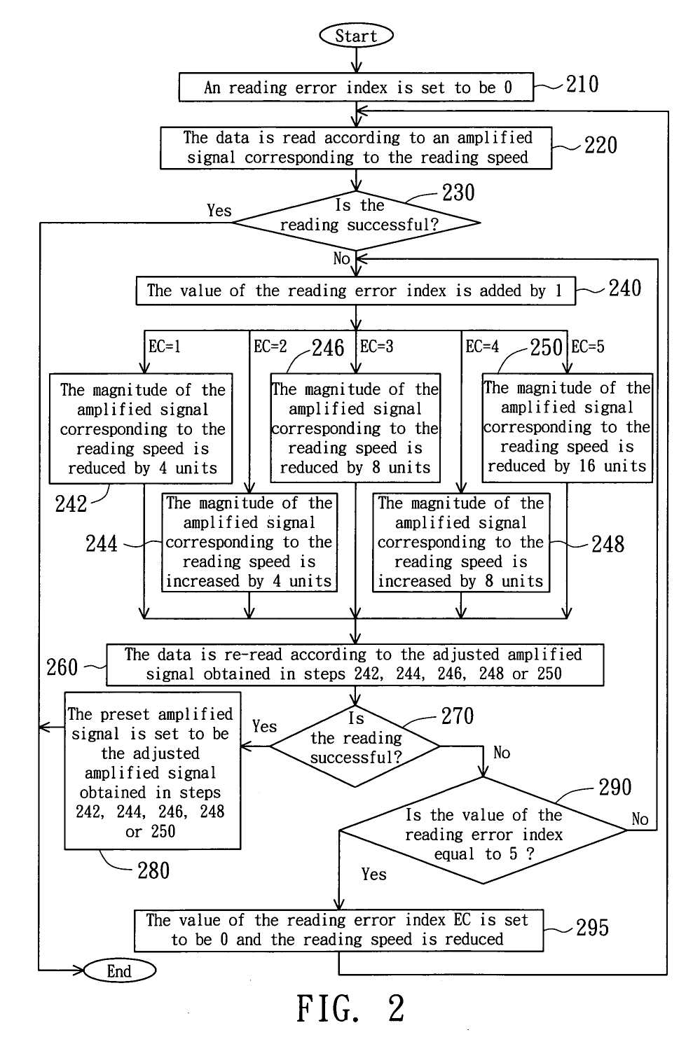

Referring to FIG. 2, a flowchart of a reading method according to a preferred embodiment of the invention is shown. The method reads the data from the optical disc at a reading speed. The optical disc can be a CDR, CDRW, DVD+R/RW or DVD−R/RW optical disc.

The method is started when the optical read/write control system reads data from an optical disc at a reading speed of 52× for instance. Firstly, the value of a reading error index EC is set to be 0 as shown in step 210. Next, the data is read according to an amplified signal corresponding to the reading speed as shown in step 220. The amplified signal corresponding to the reading speed is a preset amplified signal. The values of the amplified signals are preset according to various reading speeds and recorded in the optical read/write control system before leaving the factory. Then, whether the reading is successful is determined as shown in step 230: if the reading is successful, the method is terminated, otherwise, step 240 is processed.

If the reading is unsuccessful in step 230, the value of the reading error index EC is added by 1 as shown in step 240. The value of the reading error index EC is equal to the occurrences of unsuccessful reading. Next, if the value of the reading error index EC is equal to 1, the magnitude of the amplified signal corresponding to the reading speed is reduced by 4 units as shown in step 242. If the value of the reading error index EC is equal to 2, the magnitude of the amplified signal corresponding to the reading speed is increased by 4 units as shown in step 244. If the value of the reading error index EC is equal to 3, the magnitude of the amplified signal corresponding to the reading speed is reduced by 8 units as shown in step 246. If the value of the reading error index EC is equal to 4, the magnitude of the amplified signal corresponding to the reading speed is increased by 8 units as shown in step 248. If the value of the reading error index EC is equal to 5, the magnitude of the amplified signal corresponding to the reading speed is reduced by 16 units as shown in step 250.

The method of adjusting the above magnitudes of the amplified signals corresponding to the reading speeds enables the adjusted magnitude of the amplified signal to be larger or smaller than the preset magnitude of the amplified signal. However, the adjustment of the magnitude of the amplified signal corresponding to the reading speed is not limited thereto. For example, when the values of the reading error index EC are respectively equal to 1, 2, 3, 4 and 5, the magnitudes of the amplified signals corresponding to the reading speeds can respectively be increased by 3 units, reduced by 3 units, increased by 6 units, reduced by 6 units and increased by 9 units.

Next, the data is re-read according to the adjusted amplified signal obtained in steps 242, 244, 246, 248 or 250 as shown in step 260. Then, whether the reading is successful is determined as shown in step 270. If the reading is successful, step 280 is executed, and the method is terminated. The amplified signal adjusted in steps 242, 244, 246, 248 or 250 is a corrected amplified signal. In step 280, the preset amplified signal is set to be the adjusted amplified signal obtained in steps 242, 244, 246, 248 or 250. If the reading is unsuccessful, proceed to step 290.

If the reading is unsuccessful in step 270, whether the value of the reading error index EC is equal to 5 is determined in step 290. If the value of the reading error index EC is not equal to 5, and step 240 is repeated. If the value of the reading error index EC is equal to 5, the value of the reading error index EC is set to be 0, the reading speed is reduced from 52× to 48× as shown in step 295, and step 220 is repeated.

That is to say, when the optical read/write control system is ready to read the data at a certain address from an optical disc at a reading speed, the data is read according to an amplified signal corresponding to the reading speed. If the reading is unsuccessful, the magnitude of the amplified signal corresponding to the reading speed is adjusted according to the value of the reading error index EC, and then the data is re-read according to the adjusted amplified signal. If the reading is found to be successful after re-reading, the preset amplified signal is corrected to be the amplified signal used in re-reading, and the method is terminated. If the data stored at the address still cannot be correctly read after several times of repeats, the reading speed is reduced then the data is re-read until the data stored at the address is correctly read out.

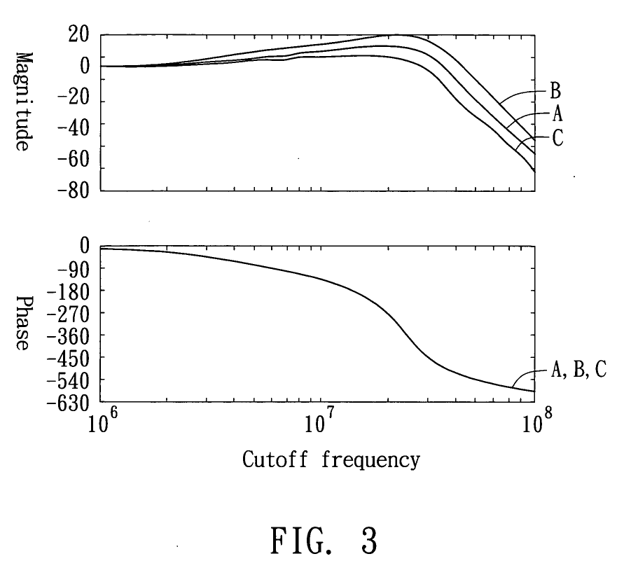

It is found from the experiment that the phase of the amplified signal is not affected when the magnitude of the amplified signal is adjusted within a certain range. For a detained elaboration, referring to FIG. 3, a Bode diagram of an amplified signal is shown. FIG. 3 can be divided into the upper part and the lower part. The upper part is a magnitude diagram of the Bode diagram, while the lower part is a phase diagram of the Bode diagram. It can be seen from the magnitude diagram of the Bode diagram that the magnitude of an amplified signal A ranges between an amplified signal B and an amplified signal C, and it can be seen from the phase of the Bode diagram that the corresponding phases of the amplified signals A, B and C are all the same.

In other words, suppose that the amplified signal A of FIG. 3 is the preset amplified signal corresponding to the reading speed of 52× and that the amplified signals B and C respectively are the first critical signal and the second critical signal. If the optical read/write control system uses the amplified signal A, an amplified signal corresponding to the reading speed of 52×, to read data at a certain address of an optical disc and fails, by adjusting the magnitude of the amplified signal corresponding to the reading speed of 52× to be between the amplified signal B and the amplified signal C, and then re-reading the data according to the adjusted amplified signal, the amplified signal used in re-reading the data can have the same phase as the preset amplified signal.

In the reading method of the embodiment, if the optical read/write control system reads the data at a certain address of an optical disc according to an amplified signal corresponding to the reading speed and fails, the data is re-read for up to 5 times. If the data stored at the address still cannot be successfully re-read after 5 repeats, the reading speed is reduced, and then the data is re-read again. However, the number of repeats can be set before leaving the factory and is not necessarily limited to 5. For example, the number of repeats can be set to be 6.

Compared with the conventional reading method, the invention performs more limited adjustment on the amplified signal corresponding to the reading speed according to the value of the reading error index EC. Consequently, the data can be quickly read out from the optical disc. Moreover, when the optical read/write control system successfully uses the adjusted amplified signal to re-read the data at the same address, the preset amplified signal is corrected to be the amplified signal used in re-reading the data. By doing so, the subsequent reading is made easier.

The reading method disclosed in above embodiment of the invention is capable of correctly and quickly reading out the data stored in an optical disc with a poor writing quality, thus enhancing the reading ability of an optical disc drive.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for reading data from an optical disc at a reading speed, comprising:
(a) reading the data according to a preset amplified signal corresponding to the reading speed;
(b) determining if the reading is successful; if so, terminating the method; otherwise, proceeding to the next step;
(c) adjusting the preset amplified signal to a corrected amplified signal according to a reading error index value;
(d) re-reading the data according to the amplified signal adjusted and corrected in the step (c); and
(e) determining if the reading is successful; if not successful, repeating step (c)

2. The method according to claim 1, wherein the value of the reading error index is equal to the occurrences of unsuccessful reading of the data.

3. The method according to claim 1, wherein the preset magnitude of the amplified signal is adjusted in step (c)

4. The method according to claim 1, wherein the magnitude of the corrected amplified signal adjusted in step (c) ranges between the preset magnitude of the amplified signal and the magnitude of a first critical signal or a second critical signal, the magnitude of the first critical signal is larger than the preset magnitude of the amplified signal, and the magnitude of the second critical signal is smaller than the preset magnitude of the amplified signal.

5. The method according to claim 1, wherein in step (c), the preset magnitude of the amplified signal is reduced by or increased by P units when the value of the reading error index is equal to 1 or 2, and P is a positive integer larger than 1.

6. The method according to claim 5, wherein in step (c), the preset magnitude of the amplified signal is reduced by or increased by Q units when the value of the reading error index is equal to 3 or 4, Q is a positive integer larger than 1 and larger than P.

7. The method according to claim 6, wherein in step (c), the preset magnitude of the amplified signal is reduced by or increased by R units when the value of the reading error index is equal to 5, and R is a positive integer larger than 1 and larger than Q.

8. The method according to claim 1, wherein if the reading is still unsuccessful in step (e) when the value of the reading error index is equal to a positive integer N, the value of the reading error index is set to 0, the reading speed is reduced, and step (a) is repeated.

9. The method according to claim 8, wherein N is equal to positive integer 5.

10. The method according to claim 1, wherein in step (e), if the reading is found to be successful, the preset amplified signal is set to be the corrected amplified signal adjusted in step (c)

11. A method for reading data from an optical disc at a reading speed, comprising:
reading the data according to a preset amplified signal corresponding to the reading speed; and
adjusting the preset amplified signal according to an index value when the preset amplified signal is used to read the data and reading error occurs.

12. The method according to claim 11, wherein the index value is a reading error index value.

13. The method according to claim 12, wherein the value of the reading error index is equal to the occurrences of reading error of the data.

14. The method according to claim 11, wherein the adjusting of the preset amplified signal is to adjust the preset magnitude of the amplified signal corresponding to the reading speed.

15. The method according to claim 14, wherein the magnitude of an adjusted amplified signal ranges between the preset magnitude of the amplified signal and the magnitude of a first critical signal or a second critical signal, the magnitude of the first critical signal is larger than the preset magnitude of the amplified signal, and the magnitude of the second critical signal is smaller than the preset magnitude of the amplified signal.

16. The method according to claim 12, wherein the preset magnitude of the amplified signal corresponding to the reading speed is reduced by or increased by P units when the value of the reading error index is equal to 1 or 2, and P is a positive integer larger than 1.

17. The method according to claim 16, wherein the preset magnitude of the amplified signal corresponding to the reading speed is reduced by or increased by Q units when the value of the reading error index is equal to 3 or 4, and Q is equal to a positive integer larger than 1 and larger than P.

18. The method according to claim 17, wherein the preset magnitude of the amplified signal corresponding to the reading speed is reduced by or increased by R units when the value of the reading error index is equal to 5, and R is a positive integer larger than 1 and larger than Q.

19. The method according to claim 12, wherein when the value of the reading error index is equal to a positive integer N, implies that reading error occurs at the reading speed, the value of the reading error index is set to be 0, the reading speed is reduced, and the data is re-read according to a reduced reading speed.

20. The method according to claim 19, wherein N is a positive integer larger than 1.
